(19) United States
(12) Patent Application Publication
(10) Pub. No.: US 2010/0288022 A1
(43) Pub. Date: Nov. 18, 2010

(54) NOVEL CHROMATOGRAPHY METHODS

(75) Inventors: E.K.S. Vijaya Kumar, Maharashtra (IN); Amit Samel, Maharashtra (IN); Sachin Patil, Maharashtra (IN); Dilip Dhore, Maharashtra (IN)

Correspondence Address: FULBRIGHT & JAWORSKI L.L.P.;Attn: MN IP Docket, 600 Congress Avenue, Suite 2400, Austin, TX, 78701, US

(73) Assignee: MYLAN INDIA PRIVATE LIMITED, District Raigad, Maharashtra (IN)

(21) Appl. No.: 12/739,754

(22) PCT Filed: Oct. 18, 2008
(86) PCT No.: PCT/GB2008/050963

§ 371 Date: Aug. 5, 2010

(30) Foreign Application Priority Data
Oct. 29, 2007 (IN) 2142/MUM/2007

(51) Int. Cl. G01N 11/00; G01N 27/447

(52) U.S. Cl. 73/53.01; 204/461

(57) ABSTRACT

The present invention relates to novel HPLC methods for the analysis of the API formoterol and related substances. In a first method the mobile phase comprises two or more liquids, and the relative concentration of the liquids is varied to a predetermined gradient. In a second method the mobile phase comprises a first liquid A comprising an aqueous solution of ammonium acetate and a second liquid B comprising a dipolar aprotic solvent. In a third method the mobile phase comprises a first liquid A comprising an aqueous solution of ammonium acetate with a concentration of 0.001 to 0.025M, and a second liquid B. The present invention also relates to a method for analysing a substance, comprising the detection and optional quantification of one or more specific impurities.

### CROSS-REFERENCE TO RELATED APPLICATION(s)

This application is a Section 371 National Stage Application of International No. PCT/GB2008/050963, filed 18 Oct. 2008 and published as WO 2009/056872 A2 on 07 May 2009, which claims priority from the IN Patent Application No. 2142/MUM/2007, filed 29 Oct. 2007, the contents of which are incorporated herein in their entirety for all purposes.

### FIELD OF THE INVENTION

The present invention relates to novel HPLC methods for the analysis of the API formoterol and related substances. In a first method the mobile phase comprises two or more liquids, and the relative concentration of the liquids is varied to a predetermined gradient. In a second method the mobile phase comprises a first liquid A comprising an aqueous solution of ammonium acetate and a second liquid B comprising a dipolar aprotic solvent. In a third method the mobile phase comprises a first liquid A comprising an aqueous solution of ammonium acetate with a concentration of 0.001 to 0.025M, and a second liquid B. The present invention also relates to a method for analysing a substance, comprising the detection and optional quantification of one or more specific impurities.

### BACKGROUND OF THE INVENTION

In order to secure marketing approval for a pharmaceutical product, a manufacturer must submit detailed evidence to the appropriate regulatory authorities to show that the product is suitable for release on to the market. The regulatory authority must be satisfied, inter alia, that the product is acceptable for administration to humans and that the particular pharmaceutical composition which is to be marketed is free from impurities at the time of release and that it has acceptable storage stability (shelf-life).

Submissions made to regulatory authorities therefore must include analytical data which demonstrate that impurities are absent from the active pharmaceutical ingredient (API) at the time of manufacture, or are present only at a negligible level, and that the shelf-life of the pharmaceutical composition is acceptable.

Potential impurities in APIs and pharmaceutical compositions include residual amounts of synthetic precursors (intermediates) to the API, by-products which arise during synthesis of the active agent, residual solvent, isomers of the active agent, contaminants which were present in materials used in the synthesis of the API or in the preparation of the pharmaceutical composition, and unidentified adventitious substances. Other impurities which may appear on storage include substances resulting from degradation of the active agent, for instance by oxidation or hydrolysis.

The health authorities have very stringent standards and manufacturers must demonstrate that their product is relatively free from impurities (within certain agreed limits) and that this standard is reproducible for each batch of pharmaceutical product that is produced.

The tests that are required to satisfy the relevant health authorities that the API and pharmaceutical compositions are safe and effective include a purity assay, content uniformity test, dissolution testing and related substances test. The purity assay determines the purity of the test product (analyte) when compared to a standard of a known purity, while the related substances test is used to quantify all of the impurities present in the product. The content uniformity test ensures that batches of product (e.g. a tablet) contain a uniform amount of API and the dissolution testing ensures that each batch of product has a consistent dissolution and release of the API.

When developing these methods for the analysis of either the API or the pharmaceutical composition (e.g. the tablet or capsule), the technique of choice is usually High Performance

Liquid Chromatography (HPLC) combined with a UV-Visible detector. The API and any impurities that are present in the mixture are separated on the HPLC stationary phase and they can be quantified by detection and measurement via the UV-Visible spectrometer.

HPLC is a chromatographic separating technique in which high-pressure pumps force the substance or mixture being analysed (analyte) together with a liquid solvent—the mobile phase (also referred to as the eluent)—through a separating column containing the stationary phase.

HPLC analysis may be performed in isocratic or gradient mode. An isocratic HPLC separation is one which is carried out under a constant mobile phase composition. A gradient HPLC separation is characterized by a gradual change over time in the percentage of the two or more solvents making up the mobile phase. The change in solvent often is controlled by a mixing device which mixes the solvents to produce the HPLC mobile phase just prior to its movement through the column.

If a constituent substance interacts strongly with the stationary phase, it remains in the column for a relatively long time, whereas a substance that does not interact with the stationary phase as strongly leaves the column sooner. Depending on the strength of the interactions, the various constituents of the analyte appear at the end of the separating column at different times—retention times—where they can be identified and quantified by means of a suitable detector.

Formoterol, the common chemical name for N-[2-hydroxy-5-[1-hydroxy-2-[[2-(4-methoxyphenyl)-1-methylethyl]amino]ethyl]phenyl]formamide, is a long acting beta agonist and is useful for the treatment of a range of respiratory disorders such as asthma and chronic obstructive pulmonary disease (COPD). Formoterol is currently marketed as the dihydrate form of the fumarate salt of the racemate of the enantiomers which have the RR (I) and SS configuration.

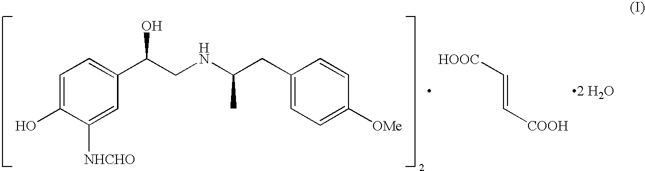

Methods for the preparation of formoterol are known in the art and these methods include those disclosed in U.S. Pat. No. 3,994,974.

Several methods have been published in the literature to analyse formoterol but these various methods have been primarily developed for the detection and determination of formoterol in biological fluids (see, for example, the methods disclosed by J. Campestrini et al. in J. Chromatography B, 704, pages 221-229, 1997; and by D. K. Nadarassan et al. in J. Chromatography B, 850, pages 31-37, 2007). Alternative HPLC methods have been published which are more suited to the analysis of formoterol in bulk drug products (see, for example, S. O. Akapo & M. Asif in J. Pharm. Biomed. Anal., 33, pages 935-945, 2003) or in an aerosol formulation (see K. H. Assi et al. in J. Pharm. Biomed. Anal., 41, pages 325-328, 2006).

Additionally, an official monograph on formoterol fumarate dihydrate appeared in European Pharmacopoeia 5.0 (volume 2, pages 1632-1634, 2005), but two different HPLC methods have to be employed to detect and/or measure all the named impurities or related substances.

However, all these current methods are not suitable for the detection and quantitation of all synthetic intermediates and other related substances that are present in a formoterol sample, particularly a formoterol fumarate dihydrate sample synthesized by the route disclosed in U.S. Pat. No. 3,994,974. Current methods are also deficient in estimating the total impurities in formoterol fumarate dihydrate.

Therefore, the HPLC methods reported in the prior art are not particularly convenient or suitable for analysing formoterol as a bulk drug substance, particularly with respect to related substances.

Consequently, although several HPLC methods have been disclosed for the analysis of formoterol and its impurities, there is still a need for an alternative method which avoids the problems associated with the known methods as discussed above.

### SUMMARY OF THE INVENTION

The present invention surprisingly provides a validated, novel, efficient, reproducible and simple HPLC method to analyse formoterol, particularly with respect to the related substances formed during the synthesis.

The present invention provides a novel method for analysing formoterol, its impurities and related substances as an alternative to known prior art methods, preferably whilst avoiding the typical prior art problems associated with the prior art methods

The present invention further provides a novel, accurate and sensitive HPLC method for the quantification of intermediates that are formed and may remain in batches of formoterol fumarate dihydrate, especially when synthesized by the process disclosed in U.S. Pat. No. 3,994,974.

The term “formoterol” as used herein throughout the description and claims means formoterol and/or any salt, solvate, isomer, diastereomer or enantiomer thereof. Preferably formoterol is used in the dihydrate form of the fumarate salt of the racemate of the enantiomers which have the RR and SS configuration.

A first aspect of the current invention provides a HPLC method for analysing formoterol, wherein the mobile phase comprises two or more liquids, including a first liquid A and a second liquid B, and the relative concentration of the liquids is varied to a predetermined gradient. In a preferred embodiment, there is provided a HPLC method for the analysis of formoterol and related substances, wherein the mobile phase comprises two or more liquids, the relative concentration of the liquids is varied to a predetermined gradient and the stationary phase used is reverse phase.

Preferably, the first liquid A is aqueous based, such as water or an aqueous solution of a buffer.

Preferably, the buffer is an acid or an organic salt or an inorganic salt.

Typically, the buffer is a phosphate salt, an acetate salt, a formate salt or trifluoroacetic acid. Most preferably, the buffer is an ammonium salt, such as ammonium acetate.

The buffer can be present at a concentration of 0.001 to 0.1 M, preferably at a concentration of 0.001 to 0.01 M, more preferably at a concentration of 0.005 to 0.01 M, more preferably at a concentration of approximately 0.007 M.

Preferably the buffer is ammonium acetate present at a concentration of 0.001 to 0.01 M. Most preferably, the buffer is ammonium acetate present at a concentration of approximately 0.007 M.

Preferably, the pH of the buffer is approximately 2 to 6, more preferably the pH is between 3.8 and 5.8, more preferably the pH of the buffer is about 4.8.

Typically, the method of the first aspect of the current invention is carried out at a temperature between approximately 15 to 40° C.

The second liquid B is preferably an organic solvent, such as methanol, ethanol, acetonitrile, propanol or isopropanol or a mixture thereof.

In one embodiment of the first aspect of the current invention the second liquid B is a substantially water miscible solvent.

As used herein, the term “substantially miscible” in relation to two liquids X and Y means that when mixed together at 20° C. and 1 atmosphere pressure, X and Y form a single phase between two mole fractions of Y, x_{Y1} and x_{Y2}, wherein the magnitude of Δx_{Y} (=x_{Y2}−x_{Y1}) is at least 0.05. For example, X and Y may form a single phase where the mole fraction of Y, x_{Y}, is from 0.40 to 0.45, or from 0.70 to 0.75; in both cases Δx_{Y}=0.05. Preferably, the magnitude of Δx_{Y} is at least 0.10, more preferably at least 0.25, more preferably at least 0.50, more preferably at least 0.75, more preferably at least 0.90, even more preferably at least 0.95. Most preferably the term “substantially miscible” in relation to two liquids X and Y means that when mixed together at 20° C. and 1 atmosphere pressure, X and Y form a single phase when mixed together in any proportion.

Preferably the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF. More preferably where the second liquid B is a dipolar aprotic solvent, it is selected from acetone, acetonitrile, dimethoxyethane or 1,4-dioxane. Most preferably, the second liquid B is acetonitrile.

A preferred embodiment of the first aspect of the current invention is when the first liquid A is an aqueous solution of ammonium acetate and the second liquid B is acetonitrile.

Preferably a mobile phase flow rate of between 0.01 and 10 ml/min is used, more preferably a mobile phase flow rate of between 0.1 and 4 ml/min is used, more preferably a mobile phase flow rate of about 1 ml/min is used.

Typically, the first aspect of the current invention comprises a gradient programming so that the relative concentration of the liquids A and B are varied to a gradient between 99.5% A:0.5% B to 0.5% A:99.5% B over 10 to 180 minutes. Preferably, the gradient is between 99.5% A:0.5% B to 0.5% A:99.5% B over 30 to 120 minutes. More preferably, the gradient is between 99.5% A:0.5% B to 0.5% A:99.5% B over 30 to 60 minutes.

Alternatively, the first aspect of the current invention may comprise a gradient programming so that the relative concentration of the liquids A and B are varied to a gradient from about 95% A:5% B, or from about 90% A:10% B, or from about 85% A:15% B, to about 5% A:95% B, or to about 10% A:90% B, or to about 15% A:85% B. The variation in gradient may typically take place over 10 to 180 minutes, preferably over 30 to 120 minutes, more preferably over 30 to 60 minutes.

A particularly preferred embodiment of the first aspect of the current invention is when the first liquid A is an aqueous solution of 0.007 M ammonium acetate and the second liquid B is acetonitrile.

A particularly preferred method according to the first aspect of the current invention is when the first liquid A is an aqueous solution of 0.007 M ammonium acetate and the second liquid B is acetonitrile and the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

In one embodiment of the first aspect of the current invention, the stationary phase is chiral. In another embodiment, the mobile phase further comprises a chiral selector.

Preferably, the stationary phase used in the first aspect of the current invention is reverse phase such as octadecylsilyl silica gel, octylsilyl silica gel, phenylalkyl silica gel, cyanopropyl silica gel, aminopropyl silica gel or an alkyl-diol silica gel. Particularly suitable stationary phases include octadecylsilyl silica gel or octylsilyl silica gel. A particularly preferred stationary phase comprises a YMC Pack pro C18 (250 mm×4.6 mm), 5μ column, preferably with a 12 nm pore size.

Preferably the stationary phase has a particle size of between 0.1 and 100 μm, or between 0.5 and 25 μm, or between 1 and 10 μm. More preferably the stationary phase has a particle size of about 5 μm.

Preferably the stationary phase has a pore size of between 1 and 100 nm, or between 2 and 40 nm, or between 5 and 15 nm. More preferably the stationary phase has a pore size of about 12 nm.

In one embodiment of the first aspect of the current invention, the chromatography is carried out in a column between 10 mm and 5000 mm in length, or in a column between 50 mm and 1000 mm in length, or between 100 mm and 500 mm in length. More preferably the chromatography is carried out in a column about 250 mm in length.

The chromatography may be carried out in a column between 0.01 mm and 100 mm in internal diameter, or between 0.1 mm and 50 mm in internal diameter, or between 1 mm and 10 mm in internal diameter. More preferably the chromatography is carried out in a column about 4.6 mm in internal diameter.

The eluent may be analysed by a detector such as a UV or visible spectrophotometer, a fluorescence spectrophotometer, a differential refractometer, an electrochemical detector, a mass spectrometer, a light scattering detector or a radioactivity detector.

In a preferred embodiment of the first aspect of the current invention, the formoterol is in the form of formoterol fumarate dihydrate.

In one embodiment of the first aspect of the current invention the HPLC method detects and optionally quantifies in a single run one or more of the following impurities:

N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I; 4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

In a preferred embodiment the HPLC method according to the current invention efficiently detects and quantifies in a single run all impurities including those selected from the following compounds:

N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II;
4-Benzyloxy-3-formylamino-α-[N-benzyl-N-(1-methyl-2-p-methoxyphenylethyl) aminomethyl] benzyl alcohol.

A second aspect of the current invention provides a HPLC method for analysing formoterol, wherein the mobile phase comprises two or more liquids, including a first liquid A comprising an aqueous solution of ammonium acetate and a second liquid B comprising a dipolar aprotic solvent.

Preferably the aqueous solution of ammonium acetate has a concentration of 0.001 to 0.1 M, more preferably the aqueous solution of ammonium acetate has a concentration of 0.001 to 0.01 M, or of 0.005 to 0.01 M. More preferably the aqueous solution of ammonium acetate has a concentration of approximately 0.007 M.

Preferably, the pH of the aqueous solution is approximately 2 to 6, more preferably the pH is between 3.8 and 5.8, more preferably the pH of the aqueous solution is about 4.8.

In one embodiment of the second aspect of the current invention the second liquid B is a substantially water miscible solvent.

Preferably the second liquid B is selected from acetone, acetonitrile, dimethoxyethane, DMF, DMSO, 1,4-dioxane, pyridine, or THF. More preferably the second liquid B is selected from acetone, acetonitrile, dimethoxyethane or 1,4-dioxane. Most preferably the second liquid B is acetonitrile.

Preferably a mobile phase flow rate of between 0.01 and 10 ml/min is used, more preferably a mobile phase flow rate of between 0.1 and 4 ml/min is used, more preferably a mobile phase flow rate of about 1 ml/min is used.

In one embodiment of the second aspect of the current invention the HPLC method is an isocratic method, preferably such that the relative concentration of the liquids A and B is set between 99.5% A:0.5% B and 0.5% A:99.5% B, or between 90% A:10% B and 10% A:90% B, more preferably between 75% A:25% B and 25% A:75% B. More preferably the relative concentration of the liquids A and B is about 40% A:60% B.

In an alternate embodiment of the second aspect of the current invention the relative concentration of the liquids of the mobile phase is varied to a predetermined gradient. Typically, a gradient programming is used so that the relative concentration of the liquids A and B are varied to a gradient between 99.5% A:0.5% B to 0.5% A:99.5% B over 10 to 180 minutes. Preferably, the gradient is between 99.5% A:0.5% B to 0.5% A:99.5% B over 30 to 120 minutes. More preferably, the gradient is between 99.5% A:0.5% B to 0.5% A:99.5% B over 30 to 60 minutes. Alternatively, a gradient programming may be used so that the relative concentration of the liquids A and B are varied to a gradient from about 95% A:5% B, or from about 90% A:10% B, or from about 85% A:15% B, to about 5% A:95% B, or to about 10% A:90% B, or to about 15% A:85% B. The variation in gradient may typically take place over 10 to 180 minutes, preferably over 30 to 120 minutes, more preferably over 30 to 60 minutes.

A particularly preferred method according to the second aspect of the current invention is when the first liquid A is an aqueous solution of 0.007 M ammonium acetate and the second liquid B is acetonitrile and the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

In one embodiment of the second aspect of the current invention, the stationary phase is chiral. In another embodiment, the mobile phase further comprises a chiral selector.

Preferably, the stationary phase used in the second aspect of the current invention is reverse phase such as octadecylsilyl silica gel, octylsilyl silica gel, phenylalkyl silica gel, cyanopropyl silica gel, aminopropyl silica gel or an alkyl-diol silica gel. Particularly suitable stationary phases include octadecylsilyl silica gel or octylsilyl silica gel. A particularly preferred stationary phase comprises a YMC Pack pro C18 (250 mm×4.6 mm), 5μ column, preferably with a 12 nm pore size.

Preferably the stationary phase has a particle size of between 0.1 and 100 μm, or between 0.5 and 25 μm, or between 1 and 10 μm. More preferably the stationary phase has a particle size of about 5 μm.

Preferably the stationary phase has a pore size of between 1 and 100 nm, or between 2 and 40 nm, or between 5 and 15 nm. More preferably the stationary phase has a pore size of about 12 nm.

Typically, the method of the second aspect of the current invention is carried out at a temperature between approximately 15 to 40° C.

In one embodiment of the second aspect of the current invention, the chromatography is carried out in a column between 10 mm and 5000 mm in length, or in a column between 50 mm and 1000 mm in length, or between 100 mm and 500 mm in length. More preferably the chromatography is carried out in a column about 250 mm in length.

The chromatography may be carried out in a column between 0.01 mm and 100 mm in internal diameter, or between 0.1 mm and 50 mm in internal diameter, or between 1 mm and 10 mm in internal diameter. More preferably the chromatography is carried out in a column about 4.6 mm in internal diameter.

The eluent may be analysed by a detector such as a UV or visible spectrophotometer, a fluorescence spectrophotometer, a differential refractometer, an electrochemical detector, a mass spectrometer, a light scattering detector or a radioactivity detector.

In a preferred embodiment of the second aspect of the current invention, the formoterol is in the form of formoterol fumarate dihydrate.

In one embodiment of the second aspect of the current invention the HPLC method detects and optionally quantifies in a single run one or more of the following impurities:

N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

A third aspect of the current invention provides a HPLC method for analysing formoterol, wherein the mobile phase comprises two or more liquids, including a first liquid A comprising an aqueous solution of ammonium acetate with a concentration of 0.001 to 0.025 M, and a second liquid B.

Preferably the aqueous solution of ammonium acetate has a concentration of 0.001 to 0.01 M, more preferably the aqueous solution of ammonium acetate has a concentration of 0.005 to 0.01 M. More preferably the aqueous solution of ammonium acetate has a concentration of approximately 0.007 M.

Preferably, the pH of the aqueous solution is approximately 2 to 6, more preferably the pH is between 3.8 and 5.8, more preferably the pH of the aqueous solution is about 4.8.

The second liquid B of the third aspect of the current invention is preferably an organic solvent, such as methanol, ethanol, acetonitrile, n-propanol or isopropanol or a mixture thereof.

In one embodiment of the third aspect of the current invention the second liquid B is a substantially water miscible solvent.

Preferably the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF. More preferably where the second liquid B is a dipolar aprotic solvent, it is selected from acetone, acetonitrile, dimethoxyethane or 1,4-dioxane. Most preferably, the second liquid B is acetonitrile.

Preferably a mobile phase flow rate of between 0.01 and 10 ml/min is used, more preferably a mobile phase flow rate of between 0.1 and 4 ml/min is used, more preferably a mobile phase flow rate of about 1 ml/min is used.

In one embodiment of the third aspect of the current invention the HPLC method is an isocratic method, preferably such that the relative concentration of the liquids A and B is set between 99.5% A:0.5% B and 0.5% A:99.5% B, or between 90% A:10% B and 10% A:90% B, more preferably between 75% A:25% B and 25% A:75% B. More preferably the relative concentration of the liquids A and B is about 40% A:60% B.

In an alternate embodiment of the third aspect of the current invention the relative concentration of the liquids of the mobile phase is varied to a predetermined gradient. Typically, a gradient programming is used so that the relative concentration of the liquids A and B are varied to a gradient between 99.5% A:0.5% B to 0.5% A:99.5% B over 10 to 180 minutes. Preferably, the gradient is between 99.5% A:0.5% B to 0.5% A:99.5% B over 30 to 120 minutes. More preferably, the gradient is between 99.5% A:0.5% B to 0.5% A:99.5% B over 30 to 60 minutes. Alternatively, a gradient programming may be used so that the relative concentration of the liquids A and B are varied to a gradient from about 95% A:5% B, or from about 90% A:10% B, or from about 85% A:15% B, to about 5% A:95% B, or to about 10% A:90% B, or to about 15% A:85% B. The variation in gradient may typically take place over 10 to 180 minutes, preferably over 30 to 120 minutes, more preferably over 30 to 60 minutes.

A particularly preferred method according to the third aspect of the current invention is when the first liquid A is an aqueous solution of 0.007 M ammonium acetate and the second liquid B is acetonitrile and the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

In one embodiment of the third aspect of the current invention, the stationary phase is chiral. In another embodiment, the mobile phase further comprises a chiral selector.

Preferably, the stationary phase used in the third aspect of the current invention is reverse phase such as octadecylsilyl silica gel, octylsilyl silica gel, phenylalkyl silica gel, cyanopropyl silica gel, aminopropyl silica gel or an alkyl-diol silica gel. Particularly suitable stationary phases include octadecylsilyl silica gel or octylsilyl silica gel. A particularly preferred stationary phase comprises a YMC Pack pro C18 (250 mm×4.6 mm), 5μ column, preferably with a 12 nm pore size.

Preferably the stationary phase has a particle size of between 0.1 and 100 μm, or between 0.5 and 25 μm, or between 1 and 10 μm. More preferably the stationary phase has a particle size of about 5 μm.

Preferably the stationary phase has a pore size of between 1 and 100 nm, or between 2 and 40 nm, or between 5 and 15 nm. More preferably the stationary phase has a pore size of about 12 nm.

Typically, the method of the third aspect of the current invention is carried out at a temperature between approximately 15 to 40° C.

In one embodiment of the third aspect of the current invention, the chromatography is carried out in a column between 10 mm and 5000 mm in length, or in a column between 50 mm and 1000 mm in length, or between 100 mm and 500 mm in length. More preferably the chromatography is carried out in a column about 250 mm in length.

The chromatography may be carried out in a column between 0.01 mm and 100 mm in internal diameter, or between 0.1 mm and 50 mm in internal diameter, or between 1 mm and 10 mm in internal diameter. More preferably the chromatography is carried out in a column about 4.6 mm in internal diameter.

The eluent may be analysed by a detector such as a UV or visible spectrophotometer, a fluorescence spectrophotometer, a differential refractometer, an electrochemical detector, a mass spectrometer, a light scattering detector or a radioactivity detector.

In a preferred embodiment of the third aspect of the current invention, the formoterol is in the form of formoterol fumarate dihydrate.

In one embodiment of the third aspect of the current invention the HPLC method detects and optionally quantifies in a single run one or more of the following impurities:

N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

A fourth aspect of the current invention provides a method for analysing a substance, comprising the detection and optional quantification of one or more impurities selected from:

N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

In one embodiment of the fourth aspect of the current invention, the substance is an active pharmaceutical ingredient. Preferably the substance is formoterol, most preferably in the form of formoterol fumarate dihydrate.

In another embodiment of the fourth aspect of the current invention, the substance comprises less than 25 wt. % of the one or more impurities. Preferably, the substance comprises less than 10 wt. %, less than 5 wt. % or less than 2 wt. % of the one or more impurities. More preferably the substance comprises less than 1 wt. %, or less than 0.5 wt. % of the one or more impurities.

In another embodiment of the fourth aspect of the current invention, the method comprises the use of HLPC, preferably such that the mobile phase comprises two or more liquids, including a first liquid A and a second liquid B.

Preferably, the first liquid A is aqueous based, such as water or an aqueous solution of a buffer.

Preferably, the buffer is an acid or an organic salt or an inorganic salt.

Typically, the buffer is a phosphate salt, an acetate salt, a formate salt or trifluoroacetic acid. Most preferably, the buffer is an ammonium salt, such as ammonium acetate.

The buffer can be present at a concentration of 0.001 to 0.1 M, preferably at a concentration of 0.001 to 0.01 M, more preferably at a concentration of 0.005 to 0.01 M, most preferably at a concentration of approximately 0.007 M.

Preferably, the pH of the buffer is approximately 2 to 6, more preferably the pH is between 3.8 and 5.8, more preferably the pH of the buffer is about 4.8.

The second liquid B is preferably an organic solvent, such as methanol, ethanol, acetonitrile, n-propanol or isopropanol or a mixture thereof.

Preferably the second liquid B is a substantially water miscible solvent.

Preferably the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF. More preferably where the second liquid B is a dipolar aprotic solvent, it is selected from acetone, acetonitrile, dimethoxyethane or 1,4-dioxane. Most preferably, the second liquid B is acetonitrile.

Preferably the first liquid A is an aqueous solution of ammonium acetate and the second liquid B is acetonitrile.

Preferably a mobile phase flow rate of between 0.01 and 10 ml/min is used, more preferably a mobile phase flow rate of between 0.1 and 4 ml/min is used, more preferably a mobile phase flow rate of about 1 ml/min is used.

Preferably the method is an isocratic HPLC method, preferably such that the relative concentration of the liquids A and B is set between 99.5% A:0.5% B and 0.5% A:99.5% B, or between 90% A:10% B and 10% A:90% B, more preferably between 75% A:25% B and 25% A:75% B. More preferably the relative concentration of the liquids A and B is about 40% A:60% B.

Alternatively, the relative concentration of the liquids of the mobile phase is varied to a predetermined gradient. Typically, a gradient programming is used so that the relative concentration of the liquids A and B are varied to a gradient between 99.5% A:0.5% B to 0.5% A:99.5% B over 10 to 180 minutes. Preferably, the gradient is between 99.5% A:0.5% B to 0.5% A:99.5% B over 30 to 120 minutes. More preferably, the gradient is between 99.5% A:0.5% B to 0.5% A:99.5% B over 30 to 60 minutes. Alternatively, a gradient programming may be used so that the relative concentration of the liquids A and B are varied to a gradient from about 95% A:5% B, or from about 90% A:10% B, or from about 85% A:15% B, to about 5% A:95% B, or to about 10% A:90% B, or to about 15% A:85% B. The variation in gradient may typically take place over 10 to 180 minutes, preferably over 30 to 120 minutes, more preferably over 30 to 60 minutes.

A particularly preferred method of the fourth aspect of the current invention is when the first liquid A is an aqueous solution of 0.007 M ammonium acetate and the second liquid B is acetonitrile and the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

In one embodiment of the fourth aspect of the current invention, the stationary phase is chiral. In another embodiment, the mobile phase further comprises a chiral selector.

Preferably, the stationary phase used in the fourth aspect of the current invention is reverse phase such as octadecylsilyl silica gel, octylsilyl silica gel, phenylalkyl silica gel, cyanopropyl silica gel, aminopropyl silica gel or an alkyl-diol silica gel. Particularly suitable stationary phases include octadecylsilyl silica gel or octylsilyl silica gel. A particularly preferred stationary phase comprises a YMC Pack pro C18 (250 mm×4.6 mm), 5μ column, preferably with a 12 nm pore size.

Preferably the stationary phase has a particle size of between 0.1 and 100 μm, or between 0.5 and 25 μm, or between 1 and 10 μm. More preferably the stationary phase has a particle size of about 5 μm.

Preferably the stationary phase has a pore size of between 1 and 100 nm, or between 2 and 40 nm, or between 5 and 15 nm. More preferably the stationary phase has a pore size of about 12 nm.

Typically, the method of the fourth aspect of the current invention is carried out at a temperature between approximately 15 to 40° C.

In one embodiment of the fourth aspect of the current invention, the chromatography is carried out in a column between 10 mm and 5000 mm in length, or in a column between 50 mm and 1000 mm in length, or between 100 mm and 500 mm in length. More preferably the chromatography is carried out in a column about 250 mm in length.

The chromatography may be carried out in a column between 0.01 mm and 100 mm in internal diameter, or between 0.1 mm and 50 mm in internal diameter, or between 1 mm and 10 mm in internal diameter. More preferably the chromatography is carried out in a column about 4.6 mm in internal diameter.

The eluent may be analysed by a detector such as a UV or visible spectrophotometer, a fluorescence spectrophotometer, a differential refractometer, an electrochemical detector, a mass spectrometer, a light scattering detector or a radioactivity detector.

For the avoidance of doubt, insofar as is practicable any embodiment of a given aspect of the present invention may occur in combination with any other embodiment of the same aspect of the present invention. In addition, insofar as is practicable it is to be understood that any preferred or optional embodiment of any aspect of the present invention should also be considered as a preferred or optional embodiment of any other aspect of the present invention.

### DETAILED DESCRIPTION OF THE INVENTION

The current invention can be used to analyse formoterol API or formoterol when prepared as a pharmaceutical composition, preferably in the form of formoterol fumarate dihydrate.

The pharmaceutical compositions that can be analysed by the current invention include solid and liquid compositions and optionally comprise one or more pharmaceutically acceptable carriers or excipients. Solid form compositions include powders, tablets, pills, capsules, cachets, suppositories, and dispersible granules. Liquid compositions include solutions or suspensions which can be administered by oral, injectable or infusion routes.

The term “impurities” or “related substances” as used herein throughout the specification can mean either impurities formed in the manufacture of the API or the pharmaceutical composition and/or formed by degradation of the API or in the pharmaceutical composition on storage.

As discussed above, the HPLC methods reported in the prior art are not suitable for analysing formoterol, particularly with respect to the related substances formed in the synthesis of formoterol fumarate dihydrate synthesized using the scheme described in U.S. Pat. No. 3,994,974. A reason for the difficulties encountered in the prior art could be the large polarity differences between the related substances and formoterol fumarate dihydrate.

However, a preferred embodiment of the current invention solves this problem and efficiently detects and quantifies, in a single run, all impurities and intermediates formed in this particular synthetic process. The present invention is advantageous as the gradient method allows the elution of all polar to non-polar impurities.

The current invention is also advantageous as the method is selective, linear, precise, accurate and robust for the analysis of related substances in formoterol fumarate dihydrate. In addition, the current invention is highly sensitive and allows detection and quantification of related substances in formoterol fumarate dihydrate at levels much lower than acceptance limits specified by health authorities.

In addition, the method of the current invention can be used to easily detect and quantify all degradation impurities formed on storage of samples of formoterol. This was established by carrying out forced degradation studies as per ICH Q1A Guidelines and validated as per ICH Q2A Guidelines covering the parameters Specificity, Linearity and Range, Precision (Repeatability, Reproducibility and Intermediate Precision), Accuracy, Limit of Detection (LOD), Limit of Quantitation (LOQ), Robustness and System Suitability.

The buffer optionally used in the first liquid A can be an inorganic salt such as sodium, potassium, calcium, magnesium, lithium or aluminium salts of phosphate, acetate or formate and mixtures thereof. Alternatively the buffer can be an organic salt such as the ammonium salt of phosphate, acetate or formate and mixtures thereof. Alternatively the buffer can be a mineral acid or a carboxylic acid, such as acetic acid or trifluoroacetic acid. Preferably the first liquid A is a 0.007 M aqueous solution of ammonium acetate. Ammonium acetate is particularly advantageous to use as the buffer as it is compatible if mass spectrometry is needed as the detector (LC-MS).

The organic solvent(s) used as the second liquid B can be lower alkyl alcohols, such as methanol, ethanol, propanol, butanol or isopropanol or mixtures thereof. Alternatively, the organic solvent(s) may be tetrahydrofuran or acetonitrile or any suitable organic solvent(s). Preferably the organic solvent is acetonitrile.

Preferably the stationary phase used in the method of the current invention is selected from octadecylsilyl silica gel (RP-18) or octylsilyl silica gel (RP-8).

An internal standard reference compound may be used in the method of the current invention if required. Alternatively the concentration of the components analysed may be determined by comparison with one or more external reference compounds.

The inventors have tested the methods of the current invention extensively to show that they are reproducible, accurate, precise, linear with respect to concentration, and robust.

While the present invention has been described in terms of its specific embodiments, certain modifications and equivalents will be apparent to those skilled in the art and are intended to be included within the scope of the present invention.

The methods of the invention disclosed herein can also be used for the analysis of compounds with similar chemical structures and/or similar chemical or physical properties to formoterol.

The following paragraphs enumerated consecutively from 1 through 182 provide for various aspects of the present invention. In one embodiment, the present invention provides:

1. A HPLC method for analysing formoterol, wherein the mobile phase comprises two or more liquids, including a first liquid A and a second liquid B, and the relative concentration of the liquids is varied to a predetermined gradient.
2. A HPLC method according to paragraph 1, wherein the first liquid A is aqueous based.
3. A HPLC method according to paragraph 2, wherein the first liquid A comprises water or an aqueous solution of a buffer.
4. A HPLC method according to paragraph 3, wherein the buffer is an acid or an organic salt or an inorganic salt.
5. A HPLC method according to paragraph 4, wherein the buffer is a phosphate salt, an acetate salt, a formate salt or trifluoroacetic acid.
6. A HPLC method according to paragraph 4 or 5, wherein the buffer is an ammonium salt.
7. A HPLC method according to paragraph 6, wherein the buffer is ammonium acetate.
8. A HPLC method according to any one of paragraphs 3 to 7, wherein the buffer is present at a concentration of 0.001 to 0.1 M.
9. A HPLC method according to paragraph 8, wherein the buffer is present at a concentration of 0.001 to 0.01 M.
10. A HPLC method according to paragraph 9, wherein the buffer is present at a concentration of 0.005 to 0.01 M.
11. A HPLC method according to paragraph 10, wherein the buffer is present at a concentration of approximately 0.007 M.
12. A HPLC method according to paragraph 7, wherein the buffer is ammonium acetate present at a concentration of 0.001 to 0.01 M.
13. A HPLC method according to paragraph 12, wherein the ammonium acetate is present at a concentration of approximately 0.007 M.
14. A HPLC method according to any one of paragraphs 3 to 13, wherein the pH of the buffer is approximately 2 to 6.
15. A HPLC method according to paragraph 14, wherein the pH of the buffer is between 3.8 and 5.8.
16. A HPLC method according to paragraph 15, wherein the pH of the buffer is about 4.8.
17. A HPLC method according to any one of the preceding paragraphs, wherein the second liquid B is an organic solvent.
18. A HPLC method according to any one of the preceding paragraphs, wherein the second liquid B is a substantially water miscible solvent.
19. A HPLC method according to any one of the preceding paragraphs, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.
20. A HPLC method according to paragraph 17, wherein the second liquid B is selected from methanol, ethanol, acetonitrile, propanol, isopropanol, or a mixture thereof.
21. A HPLC method according to paragraph 20, wherein the second liquid B is acetonitrile.

22. A HPLC method according to any one of the preceding paragraphs, wherein the first liquid A is an aqueous solution of ammonium acetate and the second liquid B is acetonitrile.

23. A HPLC method according to any one of the preceding paragraphs, wherein a mobile phase flow rate of between 0.01 and 10 ml/min is used.
24. A HPLC method according to paragraph 23, wherein a mobile phase flow rate of about 1 ml/min is used.
25. A HPLC method according to any one of the preceding paragraphs, which comprises a gradient programming so that the relative concentration of the liquids A and B are varied to a gradient between 99.5% A:0.5% B to 0.5% A:99.5% B run over 10 to 180 minutes.
26. A HPLC method according to paragraph 25, wherein the gradient is run over 30 to 120 minutes.
27. A HPLC method according to paragraph 26, wherein the gradient is run over 30 to 60 minutes.
28. A HPLC method according to any one of the preceding paragraphs, wherein the first liquid A is an aqueous solution of 0.007 M ammonium acetate and the second liquid B is acetonitrile.
29. A HPLC method according to paragraph 28, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

30. A HPLC method according to any one of the preceding paragraphs, wherein the stationary phase is chiral.
31. A HPLC method according to any one of the preceding paragraphs, wherein the mobile phase further comprises a chiral selector.
32. A HPLC method according to any one of the preceding paragraphs, wherein the stationary phase is reverse phase.
33. A HPLC method according to paragraph 32, wherein the stationary phase used is octadecylsilyl silica gel, octylsilyl silica gel, phenylalkyl silica gel, cyanopropyl silica gel, aminopropyl silica gel or an alkyl-diol silica gel.
34. A HPLC method according to paragraph 33, wherein the stationary phase used is octadecylsilyl silica gel or octylsilyl silica gel.
35. A HPLC method according to paragraph 34, wherein the stationary phase comprises a YMC Pack pro C18 (250 mm×4.6 mm), 5μ column.
36. A HPLC method according to any one of the preceding paragraphs, wherein the stationary phase has a particle size of between 0.1 and 100 μm.
37. A HPLC method according to paragraph 36, wherein the stationary phase has a particle size of about 5 μm.
38. A HPLC method according to any one of the preceding paragraphs, wherein the stationary phase has a pore size of between 1 and 100 nm.
39. A HPLC method according to paragraph 38, wherein the stationary phase has a pore size of about 12 nm.
40. A HPLC method according to any one of the preceding paragraphs, wherein the chromatography is carried out at a temperature between approximately 15 to 40° C.
41. A HPLC method according to any one of the preceding paragraphs, wherein the chromatography is carried out in a column between 10 mm and 5000 mm in length.
42. A HPLC method according to paragraph 41, wherein the chromatography is carried out in a column about 250 mm in length.
43. A HPLC method according to any one of the preceding paragraphs, wherein the chromatography is carried out in a column between 0.01 mm and 100 mm in internal diameter.
44. A HPLC method according to paragraph 43, wherein the chromatography is carried out in a column about 4.6 mm in internal diameter.
45. A HPLC method according to any one of the preceding paragraphs, wherein the eluent is analysed by a detector such as a UV or visible spectrophotometer, a fluorescence spectrophotometer, a differential refractometer, an electrochemical detector, a mass spectrometer, a light scattering detector or a radioactivity detector.
46. A HPLC method according to any one of the preceding paragraphs, wherein the formoterol is in the form of formoterol fumarate dihydrate.
47. A HPLC method according to any one of the preceding paragraphs, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.
48. A HPLC method according to any one of the preceding paragraphs, which detects and quantifies in a single run all impurities including those selected from the following compounds:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II;
4-Benzyloxy-3-formylamino-α-[N-benzyl-N-(1-methyl-2-p-methoxyphenylethyl) aminomethyl] benzyl alcohol.
49. A HPLC method for analysing formoterol, wherein the mobile phase comprises two or more liquids, including a first liquid A comprising an aqueous solution of ammonium acetate and a second liquid B comprising a dipolar aprotic solvent.
50. A HPLC method according to paragraph 49, wherein the aqueous solution of ammonium acetate has a concentration of 0.001 to 0.1 M.
51. A HPLC method according to paragraph 50, wherein the aqueous solution of ammonium acetate has a concentration of 0.001 to 0.01 M.
52. A HPLC method according to paragraph 51, wherein the aqueous solution of ammonium acetate has a concentration of 0.005 to 0.01 M.
53. A HPLC method according to paragraph 52, wherein the aqueous solution of ammonium acetate has a concentration of approximately 0.007 M.
54. A HPLC method according to any one of paragraphs 49 to 53, wherein the pH of the aqueous solution is approximately 2 to 6.
55. A HPLC method according to paragraph 54, wherein the pH of the aqueous solution is between 3.8 and 5.8.
56. A HPLC method according to paragraph 55, wherein the pH of the aqueous solution is about 4.8.
57. A HPLC method according to any one of paragraphs 49 to 56, wherein the second liquid B is a substantially water miscible solvent.
58. A HPLC method according to any one of paragraphs 49 to 57, wherein the second liquid B is selected from acetone, acetonitrile, dimethoxyethane, DMF, DMSO, 1,4-dioxane, pyridine, or THF.
59. A HPLC method according to paragraph 58, wherein the second liquid B is acetonitrile.
60. A HPLC method according to any one of paragraphs 49 to 59, wherein a mobile phase flow rate of between 0.01 and 10 ml/min is used.
61. A HPLC method according to paragraph 60, wherein a mobile phase flow rate of about 1 ml/min is used.
62. A HPLC method according to any one of paragraphs 49 to 61, wherein the HPLC method is an isocratic method.
63. A HPLC method according to paragraph 62, wherein the relative concentration of the liquids A and B is set between 99.5% A:0.5% B and 0.5% A:99.5% B.
64. A HPLC method according to paragraph 63, wherein the relative concentration of the liquids A and B is about 40% A:60% B.
65. A HPLC method according to any one of paragraphs 49 to 61, wherein the relative concentration of the liquids of the mobile phase is varied to a predetermined gradient.
66. A HPLC method according to paragraph 65, which comprises a gradient programming so that the relative concentration of the liquids A and B are varied to a gradient between 99.5% A:0.5% B to 0.5% A:99.5% B run over 10 to 180 minutes.
67. A HPLC method according to paragraph 66, wherein the gradient is run over 30 to 120 minutes.
68. A HPLC method according to paragraph 67, wherein the gradient is run over 30 to 60 minutes.
69. A HPLC method according to any one of paragraphs 65 to 68, wherein the first liquid A is an aqueous solution of 0.007 M ammonium acetate and the second liquid B is acetonitrile.
70. A HPLC method according to paragraph 69, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

71. A HPLC method according to any one of paragraphs 49 to 70, wherein the stationary phase is chiral.
72. A HPLC method according to any one of paragraphs 49 to 71, wherein the mobile phase further comprises a chiral selector.
73. A HPLC method according to any one of paragraphs 49 to 72, wherein the stationary phase is reverse phase.
74. A HPLC method according to paragraph 73, wherein the stationary phase used is octadecylsilyl silica gel, octylsilyl silica gel, phenylalkyl silica gel, cyanopropyl silica gel, aminopropyl silica gel or an alkyl-diol silica gel.
75. A HPLC method according to paragraph 74, wherein the stationary phase used is octadecylsilyl silica gel or octylsilyl silica gel.
76. A HPLC method according to paragraph 75, wherein the stationary phase comprises a YMC Pack pro C18 (250 mm×4.6 mm), 5μ column.
77. A HPLC method according to any one of paragraphs 49 to 76, wherein the stationary phase has a particle size of between 0.1 and 100 μm.
78. A HPLC method according to paragraph 77, wherein the stationary phase has a particle size of about 5 μm.
79. A HPLC method according to any one of paragraphs 49 to 78, wherein the stationary phase has a pore size of between 1 and 100 nm.
80. A HPLC method according to paragraph 79, wherein the stationary phase has a pore size of about 12 nm.
81. A HPLC method according to any one of paragraphs 49 to 80, wherein the chromatography is carried out at a temperature between approximately 15 to 40° C.
82. A HPLC method according to any one of paragraphs 49 to 81, wherein the chromatography is carried out in a column between 10 mm and 5000 mm in length.
83. A HPLC method according to paragraph 82, wherein the chromatography is carried out in a column about 250 mm in length.
84. A HPLC method according to any one of paragraphs 49 to 83, wherein the chromatography is carried out in a column between 0.01 mm and 100 mm in internal diameter.
85. A HPLC method according to paragraph 84, wherein the chromatography is carried out in a column about 4.6 mm in internal diameter.
86. A HPLC method according any one of paragraphs 49 to 85, wherein the eluent is analysed by a detector such as a UV or visible spectrophotometer, a fluorescence spectrophotometer, a differential refractometer, an electrochemical detector, a mass spectrometer, a light scattering detector or a radioactivity detector.
87. A HPLC method according to any one of paragraphs 49 to 86, wherein the formoterol is in the form of formoterol fumarate dihydrate.
88. A HPLC method according to any one of paragraphs 49 to 87, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.
89. A HPLC method for analysing formoterol, wherein the mobile phase comprises two or more liquids, including a first liquid A comprising an aqueous solution of ammonium acetate with a concentration of 0.001 to 0.025 M, and a second liquid B.
90. A HPLC method according to paragraph 89, wherein the aqueous solution of ammonium acetate has a concentration of 0.001 to 0.01 M.
91. A HPLC method according to paragraph 90, wherein the aqueous solution of ammonium acetate has a concentration of 0.005 to 0.01 M.
92. A HPLC method according to paragraph 91, wherein the aqueous solution of ammonium acetate has a concentration of approximately 0.007 M.
93. A HPLC method according to any one of paragraphs 89 to 92, wherein the pH of the aqueous solution is approximately 2 to 6.
94. A HPLC method according to paragraph 93, wherein the pH of the aqueous solution is between 3.8 and 5.8.
95. A HPLC method according to paragraph 94, wherein the pH of the aqueous solution is about 4.8.
96. A HPLC method according to any one of paragraphs 89 to 95, wherein the second liquid B is an organic solvent.
97. A HPLC method according to any one of paragraphs 89 to 96, wherein the second liquid B is a substantially water miscible solvent.
98. A HPLC method according to any one of paragraphs 89 to 97, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.
99. A HPLC method according to any one of paragraphs 89 to 98, wherein the second liquid B is selected from methanol, ethanol, acetonitrile, n-propanol, isopropanol or a mixture thereof.
100. A HPLC method according to paragraph 99, wherein the second liquid B is acetonitrile.
101. A HPLC method according to any one of paragraphs 89 to 100, wherein a mobile phase flow rate of between 0.01 and 10 ml/min is used.
102. A HPLC method according to paragraph 101, wherein a mobile phase flow rate of about 1 ml/min is used.
103. A HPLC method according to any one of paragraphs 89 to 102, wherein the HPLC method is an isocratic method.
104. A HPLC method according to paragraph 103, wherein the relative concentration of the liquids A and B is set between 99.5% A:0.5% B to 0.5% A:99.5% B.
105. A HPLC method according to paragraph 104, wherein the relative concentration of the liquids A and B is about 40% A:60% B.
106. A HPLC method according to any one of paragraphs 89 to 102, wherein the relative concentration of the liquids of the mobile phase is varied to a predetermined gradient.
107. A HPLC method according to paragraph 106, which comprises a gradient programming so that the relative concentration of the liquids A and B are varied to a gradient between 99.5% A:0.5% B to 0.5% A:99.5% B run over 10 to 180 minutes.
108. A HPLC method according to paragraph 107, wherein the gradient is run over 30 to 120 minutes.
109. A HPLC method according to paragraph 108, wherein the gradient is run over 30 to 60 minutes.
110. A HPLC method according to any one of paragraphs 106 to 109, wherein the first liquid A is an aqueous solution of 0.007 M ammonium acetate and the second liquid B is acetonitrile.
111. A HPLC method according to paragraph 110, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

112. A HPLC method according to any one of paragraphs 89 to 111, wherein the stationary phase is chiral.
113. A HPLC method according to any one of paragraphs 89 to 112, wherein the mobile phase further comprises a chiral selector.
114. A HPLC method according to any one of paragraphs 89 to 113, wherein the stationary phase is reverse phase.
115. A HPLC method according to paragraph 114, wherein the stationary phase used is octadecylsilyl silica gel, octylsilyl silica gel, phenylalkyl silica gel, cyanopropyl silica gel, aminopropyl silica gel or an alkyl-diol silica gel.
116. A HPLC method according to paragraph 115, wherein the stationary phase used is octadecylsilyl silica gel or octylsilyl silica gel.
117. A HPLC method according to paragraph 116, wherein the stationary phase comprises a YMC Pack pro C18 (250 mm×4.6 mm), 5μ column.
118. A HPLC method according to any one of paragraphs 89 to 117, wherein the stationary phase has a particle size of between 0.1 and 100 μm.
119. A HPLC method according to paragraph 118, wherein the stationary phase has a particle size of about 5 μm.
120. A HPLC method according to any one of paragraphs 89 to 119, wherein the stationary phase has a pore size of between 1 and 100 nm.
121. A HPLC method according to paragraph 120, wherein the stationary phase has a pore size of about 12 nm.
122. A HPLC method according to any one of paragraphs 89 to 121, wherein the chromatography is carried out at a temperature between approximately 15 to 40° C.
123. A HPLC method according to any one of paragraphs 89 to 122, wherein the chromatography is carried out in a column between 10 mm and 5000 mm in length.
124. A HPLC method according to paragraph 123, wherein the chromatography is carried out in a column about 250 mm in length.
125. A HPLC method according to any one of paragraphs 89 to 124, wherein the chromatography is carried out in a column between 0.01 mm and 100 mm in internal diameter.
126. A HPLC method according to paragraph 125, wherein the chromatography is carried out in a column about 4.6 mm in internal diameter.
127. A HPLC method according to any one of paragraphs 89 to 126, wherein the eluent is analysed by a detector such as a UV or visible spectrophotometer, a fluorescence spectrophotometer, a differential refractometer, an electrochemical detector, a mass spectrometer, a light scattering detector or a radioactivity detector.
128. A HPLC method according to any one of paragraphs 89 to 127, wherein the formoterol is in the form of formoterol fumarate dihydrate.
129. A HPLC method according to any one of paragraphs 89 to 128, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.
130. A method for analysing a substance, comprising the detection and optional quantification of one or more impurities selected from:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.
131. A method according to paragraph 130, wherein the substance is an active pharmaceutical ingredient.
132. A method according to paragraph 130 or 131, wherein the substance is formoterol.
133. A method according to paragraph 132, wherein the formoterol is in the form of formoterol fumarate dihydrate.
134. A method according to any one of paragraphs 130 to 133, wherein the substance comprises less than 25 wt. % of the one or more impurities.
135. A method according to any one of paragraphs 130 to 134, wherein the method comprises the use of HLPC.
136. A method according to paragraph 135, wherein the mobile phase comprises two or more liquids, including a first liquid A and a second liquid B.
137. A method according to paragraph 136, wherein the first liquid A is aqueous based.
138. A method according to paragraph 137, wherein the first liquid A comprises water or an aqueous solution of a buffer.
139. A method according to paragraph 138, wherein the buffer is an acid or an organic salt or an inorganic salt.
140. A method according to paragraph 139, wherein the buffer is a phosphate salt, an acetate salt, a formate salt or trifluoroacetic acid.
141. A method according to paragraph 139 or 140, wherein the buffer is an ammonium salt.
142. A method according to paragraph 141, wherein the buffer is ammonium acetate.
143. A method according to any one of paragraphs 138 to 142, wherein the buffer is present at a concentration of 0.001 to 0.1 M.
144. A method according to paragraph 143, wherein the buffer is present at a concentration of 0.001 to 0.01 M.
145. A method according to paragraph 144, wherein the buffer is present at a concentration of 0.005 to 0.01 M.
146. A method according to paragraph 145, wherein the buffer is present at a concentration of approximately 0.007 M.
147. A method according to any one of paragraphs 138 to 146, wherein the pH of the buffer is approximately 2 to 6.
148. A method according to paragraph 147, wherein the pH of the buffer is between 3.8 and 5.8.
149. A method according to paragraph 148, wherein the pH of the buffer is about 4.8.
150. A method according to any one of paragraphs 136 to 149, wherein the second liquid B is an organic solvent.
151. A method according to any one of paragraphs 136 to 150, wherein the second liquid B is a substantially water miscible solvent.
152. A method according to any one of paragraphs 136 to 151, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.
153. A method according to paragraph 150, wherein the second liquid B is selected from methanol, ethanol, acetonitrile, n-propanol, isopropanol, or a mixture thereof.
154. A method according to paragraph 153, wherein the second liquid B is acetonitrile.
155. A method according to any one of paragraphs 136 to 154, wherein the first liquid A is an aqueous solution of ammonium acetate and the second liquid B is acetonitrile.
156. A method according to any one of paragraphs 136 to 155, wherein a mobile phase flow rate of between 0.01 and 10 ml/min is used.
157. A method according to paragraph 156, wherein a mobile phase flow rate of about 1 ml/min is used.
158. A method according to any one of paragraphs 136 to 157, wherein the method is an isocratic HPLC method.
159. A method according to paragraph 158, wherein the relative concentration of the liquids A and B is set between 99.5% A:0.5% B and 0.5% A:99.5% B.
160. A method according to paragraph 159, wherein the relative concentration of the liquids A and B is about 40% A:60% B.
161. A method according to any one of paragraphs 136 to 157, wherein the relative concentration of the liquids of the mobile phase is varied to a predetermined gradient.
162. A method according to paragraph 161, which comprises a gradient programming so that the relative concentration of the liquids A and B are varied to a gradient between 99.5% A:0.5% B to 0.5% A:99.5% B run over 10 to 180 minutes.
163. A method according to paragraph 162, wherein the gradient is run over 30 to 120 minutes.
164. A method according to paragraph 163, wherein the gradient is run over 30 to 60 minutes.
165. A method according to any one of paragraphs 161 to 164, wherein the first liquid A is an aqueous solution of 0.007 M ammonium acetate and the second liquid B is acetonitrile.
166. A method according to paragraph 165, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

167. A method according to any one of paragraphs 136 to 166, wherein the stationary phase is chiral.
168. A method according to any one of paragraphs 136 to 167, wherein the mobile phase further comprises a chiral selector.
169. A method according to any one of paragraphs 136 to 168, wherein the stationary phase is reverse phase.
170. A method according to paragraph 169, wherein the stationary phase used is octadecylsilyl silica gel, octylsilyl silica gel, phenylalkyl silica gel, cyanopropyl silica gel, aminopropyl silica gel or an alkyl-diol silica gel.
171. A method according to paragraph 170, wherein the stationary phase used is octadecylsilyl silica gel or octylsilyl silica gel.
172. A method according to paragraph 171, wherein the stationary phase comprises a YMC Pack pro C18 (250 mm×4.6 mm), 5μ column.
173. A method according to any one of paragraphs 136 to 172, wherein the stationary phase has a particle size of between 0.1 and 100 μm.
174. A method according to paragraph 173, wherein the stationary phase has a particle size of about 5 μm.
175. A method according to any one of paragraphs 136 to 174, wherein the stationary phase has a pore size of between 1 and 100 nm.
176. A method according to paragraph 175, wherein the stationary phase has a pore size of about 12 nm.
177. A method according to any one of paragraphs 136 to 176, wherein the chromatography is carried out at a temperature between approximately 15 to 40° C.
178. A method according to any one of paragraphs 136 to 177, wherein the chromatography is carried out in a column between 10 mm and 5000 mm in length.
179. A method according to paragraph 178, wherein the chromatography is carried out in a column about 250 mm in length.
180. A method according to any one of paragraphs 136 to 179, wherein the chromatography is carried out in a column between 0.01 mm and 100 mm in internal diameter.
181. A method according to paragraph 180, wherein the chromatography is carried out in a column about 4.6 mm in internal diameter.
182. A method according to any one of paragraphs 136 to 181, wherein the eluent is analysed by a detector such as a UV or visible spectrophotometer, a fluorescence spectrophotometer, a differential refractometer, an electrochemical detector, a mass spectrometer, a light scattering detector or a radioactivity detector.

The present invention is illustrated but in no way limited by the following example.

### EXAMPLE

Experimental conditions:
Column: YMC Pack pro C18 (250 mm×4.6 mm), 5μ, 12 nm pore size;

Flow rate: 1 ml/min;

### Detection: 214 nm;

Sample concentration: 2000 ppm;
Diluent: Water-Acetonitrile (1:1 v/v);
Mobile phase: 0.007 M aqueous ammonium acetate (A)-acetonitrile (B) gradient. The gradient program is described below:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

Retention Times (RT), Relative Retention Times (RRT), Limit of Detection (LOD), and Limit of Quantitation (LOQ) obtained for all the intermediates and formoterol fumarate dihydrate are summarized in Table 1.

TABLE 1
Retention Times (RT), Relative Retention Times (RRT), Limit of Detection (LOD), and
Limit of Quantitation (LOQ)

| | Approximate | Approximate | | |
|---|---|---|---|---|
| Component | RT (min) | RRT | LOD (%) | LOQ (%) |
| Formoterol fumarate dihydrate | 9.03 | 1.00 | 0.01 | 0.03 |
| N-Benzyl-N-(1-methyl-2-p-methoxyphenylethyl) amine | 12.39 | 1.37 | 0.01 | 0.03 |
| 4-Benzyloxy-3-formylamino-α-[N-benzyl-N-(1-methyl-2-p- | 24.70 | 2.74 | 0.005 | 0.015 |
| methoxy phenylethyl)aminomethyl] benzyl alcohol | | | | |
| 4-Benzyloxy-3-amino-α-[N-benzyl-N-(1-methyl-2-p- | 26.23 | 2.91 | 0.01 | 0.03 |
| methoxyphenyl ethyl)aminomethyl] benzyl alcohol diastereomer-II | | | | |
| 4-Benzyloxy-3-amino-α-[N-benzyl-N-(1-methyl-2-p- | 27.01 | 2.99 | 0.01 | 0.03 |
| methoxyphenyl ethyl)aminomethyl] benzyl alcohol diastereomer-I | | | | |
| 4-Benzyloxy-3-nitro-α-[N-benzyl-N-(1-methyl-2-p-methoxyphenyl | 29.55 | 3.28 | 0.01 | 0.03 |
| ethyl)aminomethyl] benzyl alcohol diastereomer-II | | | | |
| 4-Benzyloxy-3-nitro-α-[N-benzyl-N-(1-methyl-2-p-methoxyphenyl | 31.24 | 3.46 | 0.01 | 0.03 |
| ethyl)aminomethyl] benzyl alcohol diastereomer-I | | | | |
| 4-Benzyloxy-3-nitro-α-[N-benzyl-N-(1-methyl-2-p-methoxyphenyl | 33.28 | 3.69 | 0.01 | 0.03 |
| ethyl)amino] acetophenone | | | | |

1. A HPLC method for analysing formoterol, wherein the mobile phase comprises two or more liquids, including a first liquid A and a second liquid B, and the relative concentration of the liquids is varied to a predetermined gradient.

2. A HPLC method according to claim 1, wherein the first liquid A is aqueous based.

3. A HPLC method according to claim 2, wherein the first liquid A comprises water or an aqueous solution of a buffer.

4. A HPLC method according to claim 3, wherein the buffer is an acid or an organic salt or an inorganic salt.

5. A HPLC method according to claim 4, wherein the buffer is a phosphate salt, an acetate salt, a formate salt or trifluoroacetic acid.

6. A HPLC method according to claim 4 or 5, wherein the buffer is an ammonium salt.

7. A HPLC method according to claim 6, wherein the buffer is ammonium acetate.

8. A HPLC method according to any one of claims 3 to 7, wherein the buffer is present at a concentration of 0.001 to 0.1 M.

9. A HPLC method according to claim 8, wherein the buffer is present at a concentration of 0.001 to 0.01 M.

10. A HPLC method according to claim 9, wherein the buffer is present at a concentration of 0.005 to 0.01 M.

11. A HPLC method according to claim 10, wherein the buffer is present at a concentration of approximately 0.007 M.

12. A HPLC method according to claim 7, wherein the buffer is ammonium acetate present at a concentration of 0.001 to 0.01 M.

13. A HPLC method according to claim 12, wherein the ammonium acetate is present at a concentration of approximately 0.007 M.

14. A HPLC method according to any one of claims 3 to 13, wherein the pH of the buffer is approximately 2 to 6.

15. A HPLC method according to claim 14, wherein the pH of the buffer is between 3.8 and 5.8.

16. A HPLC method according to claim 15, wherein the pH of the buffer is about 4.8.

17. A HPLC method according to any one of the preceding claims, wherein the second liquid B is an organic solvent.

18. A HPLC method according to any one of the preceding claims, wherein the second liquid B is a substantially water miscible solvent.

19. A HPLC method according to any one of the preceding claims, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.

20. A HPLC method according to claim 17, wherein the second liquid B is selected from methanol, ethanol, acetonitrile, propanol, isopropanol, or a mixture thereof.

21. A HPLC method according to claim 20, wherein the second liquid B is acetonitrile.

22. A HPLC method according to any one of the preceding claims, wherein the first liquid A is an aqueous solution of ammonium acetate and the second liquid B is acetonitrile.

23. A HPLC method according to any one of the preceding claims, wherein a mobile phase flow rate of between 0.01 and 10 ml/min is used.

24. A HPLC method according to claim 23, wherein a mobile phase flow rate of about 1 ml/min is used.

25. A HPLC method according to any one of the preceding claims, which comprises a gradient programming so that the relative concentration of the liquids A and B are varied to a gradient between 99.5% A:0.5% B to 0.5% A:99.5% B run over 10 to 180 minutes.

26. A HPLC method according to claim 25, wherein the gradient is run over 30 to 120 minutes.

27. A HPLC method according to claim 26, wherein the gradient is run over 30 to 60 minutes.

28. A HPLC method according to any one of the preceding claims, wherein the first liquid A is an aqueous solution of 0.007 M ammonium acetate and the second liquid B is acetonitrile.

29. A HPLC method according to claim 28, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

30. A HPLC method according to any one of the preceding claims, wherein the stationary phase is chiral.

31. A HPLC method according to any one of the preceding claims, wherein the mobile phase further comprises a chiral selector.

32. A HPLC method according to any one of the preceding claims, wherein the stationary phase is reverse phase.

33. A HPLC method according to claim 32, wherein the stationary phase used is octadecylsilyl silica gel, octylsilyl silica gel, phenylalkyl silica gel, cyanopropyl silica gel, aminopropyl silica gel or an alkyl-diol silica gel.

34. A HPLC method according to claim 33, wherein the stationary phase used is octadecylsilyl silica gel or octylsilyl silica gel.

35. A HPLC method according to claim 34, wherein the stationary phase comprises a YMC Pack pro C18 (250 mm×4.6 mm), 5μ column.

36. A HPLC method according to any one of the preceding claims, wherein the stationary phase has a particle size of between 0.1 and 100 μm.

37. A HPLC method according to claim 36, wherein the stationary phase has a particle size of about 5 μm.

38. A HPLC method according to any one of the preceding claims, wherein the stationary phase has a pore size of between 1 and 100 nm.

39. A HPLC method according to claim 38, wherein the stationary phase has a pore size of about 12 nm.

40. A HPLC method according to any one of the preceding claims, wherein the chromatography is carried out at a temperature between approximately 15 to 40° C.

41. A HPLC method according to any one of the preceding claims, wherein the chromatography is carried out in a column between 10 mm and 5000 mm in length.

42. A HPLC method according to claim 41, wherein the chromatography is carried out in a column about 250 mm in length.

43. A HPLC method according to any one of the preceding claims, wherein the chromatography is carried out in a column between 0.01 mm and 100 mm in internal diameter.

44. A HPLC method according to claim 43, wherein the chromatography is carried out in a column about 4.6 mm in internal diameter.

45. A HPLC method according to any one of the preceding claims, wherein the eluent is analysed by a detector such as a UV or visible spectrophotometer, a fluorescence spectrophotometer, a differential refractometer, an electrochemical detector, a mass spectrometer, a light scattering detector or a radioactivity detector.

46. A HPLC method according to any one of the preceding claims, wherein the formoterol is in the form of formoterol fumarate dihydrate.

47. A HPLC method according to any one of the preceding claims, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

48. A HPLC method according to any one of the preceding claims, which detects and quantifies in a single run all impurities including those selected from the following compounds:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II;
4-Benzyloxy-3-formylamino-α-[N-benzyl-N-(1-methyl-2-p-methoxyphenylethyl) aminomethyl] benzyl alcohol.

49. A HPLC method for analysing formoterol, wherein the mobile phase comprises two or more liquids, including a first liquid A comprising an aqueous solution of ammonium acetate and a second liquid B comprising a dipolar aprotic solvent.

50. A HPLC method according to claim 49, wherein the aqueous solution of ammonium acetate has a concentration of 0.001 to 0.1 M.

51. A HPLC method according to claim 50, wherein the aqueous solution of ammonium acetate has a concentration of 0.001 to 0.01 M.

52. A HPLC method according to claim 51, wherein the aqueous solution of ammonium acetate has a concentration of 0.005 to 0.01 M.

53. A HPLC method according to claim 52, wherein the aqueous solution of ammonium acetate has a concentration of approximately 0.007 M.

54. A HPLC method according to any one of claims 49 to 53, wherein the pH of the aqueous solution is approximately 2 to 6.

55. A HPLC method according to claim 54, wherein the pH of the aqueous solution is between 3.8 and 5.8.

56. A HPLC method according to claim 55, wherein the pH of the aqueous solution is about 4.8.

57. A HPLC method according to any one of claims 49 to 56, wherein the second liquid B is a substantially water miscible solvent.

58. A HPLC method according to any one of claims 49 to 57, wherein the second liquid B is selected from acetone, acetonitrile, dimethoxyethane, DMF, DMSO, 1,4-dioxane, pyridine, or THF.

59. A HPLC method according to claim 58, wherein the second liquid B is acetonitrile.

60. A HPLC method according to any one of claims 49 to 59, wherein a mobile phase flow rate of between 0.01 and 10 ml/min is used.

61. A HPLC method according to claim 60, wherein a mobile phase flow rate of about 1 ml/min is used.

62. A HPLC method according to any one of claims 49 to 61, wherein the HPLC method is an isocratic method.

63. A HPLC method according to claim 62, wherein the relative concentration of the liquids A and B is set between 99.5% A:0.5% B and 0.5% A:99.5% B.

64. A HPLC method according to claim 63, wherein the relative concentration of the liquids A and B is about 40% A:60% B.

65. A HPLC method according to any one of claims 49 to 61, wherein the relative concentration of the liquids of the mobile phase is varied to a predetermined gradient.

66. A HPLC method according to claim 65, which comprises a gradient programming so that the relative concentration of the liquids A and B are varied to a gradient between 99.5% A:0.5% B to 0.5% A:99.5% B run over 10 to 180 minutes.

67. A HPLC method according to claim 66, wherein the gradient is run over 30 to 120 minutes.

68. A HPLC method according to claim 67, wherein the gradient is run over 30 to 60 minutes.

69. A HPLC method according to any one of claims 65 to 68, wherein the first liquid A is an aqueous solution of 0.007 M ammonium acetate and the second liquid B is acetonitrile.

70. A HPLC method according to claim 69, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

71. A HPLC method according to any one of claims 49 to 70, wherein the stationary phase is chiral.

72. A HPLC method according to any one of claims 49 to 71, wherein the mobile phase further comprises a chiral selector.

73. A HPLC method according to any one of claims 49 to 72, wherein the stationary phase is reverse phase.

74. A HPLC method according to claim 73, wherein the stationary phase used is octadecylsilyl silica gel, octylsilyl silica gel, phenylalkyl silica gel, cyanopropyl silica gel, aminopropyl silica gel or an alkyl-diol silica gel.

75. A HPLC method according to claim 74, wherein the stationary phase used is octadecylsilyl silica gel or octylsilyl silica gel.

76. A HPLC method according to claim 75, wherein the stationary phase comprises a YMC Pack pro C18 (250 mm×4.6 mm), 5μ column.

77. A HPLC method according to any one of claims 49 to 76, wherein the stationary phase has a particle size of between 0.1 and 100 μm.

78. A HPLC method according to claim 77, wherein the stationary phase has a particle size of about 5 μm.

79. A HPLC method according to any one of claims 49 to 78, wherein the stationary phase has a pore size of between 1 and 100 nm.

80. A HPLC method according to claim 79, wherein the stationary phase has a pore size of about 12 nm.

81. A HPLC method according to any one of claims 49 to 80, wherein the chromatography is carried out at a temperature between approximately 15 to 40° C.

82. A HPLC method according to any one of claims 49 to 81, wherein the chromatography is carried out in a column between 10 mm and 5000 mm in length.

83. A HPLC method according to claim 82, wherein the chromatography is carried out in a column about 250 mm in length.

84. A HPLC method according to any one of claims 49 to 83, wherein the chromatography is carried out in a column between 0.01 mm and 100 mm in internal diameter.

85. A HPLC method according to claim 84, wherein the chromatography is carried out in a column about 4.6 mm in internal diameter.

86. A HPLC method according any one of claims 49 to 85, wherein the eluent is analysed by a detector such as a UV or visible spectrophotometer, a fluorescence spectrophotometer, a differential refractometer, an electrochemical detector, a mass spectrometer, a light scattering detector or a radioactivity detector.

87. A HPLC method according to any one of claims 49 to 86, wherein the formoterol is in the form of formoterol fumarate dihydrate.

88. A HPLC method according to any one of claims 49 to 87, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

89. A HPLC method for analysing formoterol, wherein the mobile phase comprises two or more liquids, including a first liquid A comprising an aqueous solution of ammonium acetate with a concentration of 0.001 to 0.025 M, and a second liquid B.

90. A HPLC method according to claim 89, wherein the aqueous solution of ammonium acetate has a concentration of 0.001 to 0.01 M.

91. A HPLC method according to claim 90, wherein the aqueous solution of ammonium acetate has a concentration of 0.005 to 0.01 M.

92. A HPLC method according to claim 91, wherein the aqueous solution of ammonium acetate has a concentration of approximately 0.007 M.

93. A HPLC method according to any one of claims 89 to 92, wherein the pH of the aqueous solution is approximately 2 to 6.

94. A HPLC method according to claim 93, wherein the pH of the aqueous solution is between 3.8 and 5.8.

95. A HPLC method according to claim 94, wherein the pH of the aqueous solution is about 4.8.

96. A HPLC method according to any one of claims 89 to 95, wherein the second liquid B is an organic solvent.

97. A HPLC method according to any one of claims 89 to 96, wherein the second liquid B is a substantially water miscible solvent.

98. A HPLC method according to any one of claims 89 to 97, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.

99. A HPLC method according to any one of claims 89 to 98, wherein the second liquid B is selected from methanol, ethanol, acetonitrile, n-propanol, isopropanol or a mixture thereof.

100. A HPLC method according to claim 99, wherein the second liquid B is acetonitrile.

101. A HPLC method according to any one of claims 89 to 100, wherein a mobile phase flow rate of between 0.01 and 10 ml/min is used.

102. A HPLC method according to claim 101, wherein a mobile phase flow rate of about 1 ml/min is used.

103. A HPLC method according to any one of claims 89 to 102, wherein the HPLC method is an isocratic method.

104. A HPLC method according to claim 103, wherein the relative concentration of the liquids A and B is set between 99.5% A:0.5% B to 0.5% A:99.5% B.

105. A HPLC method according to claim 104, wherein the relative concentration of the liquids A and B is about 40% A:60% B.

106. A HPLC method according to any one of claims 89 to 102, wherein the relative concentration of the liquids of the mobile phase is varied to a predetermined gradient.

107. A HPLC method according to claim 106, which comprises a gradient programming so that the relative concentration of the liquids A and B are varied to a gradient between 99.5% A:0.5% B to 0.5% A:99.5% B run over 10 to 180 minutes.

108. A HPLC method according to claim 107, wherein the gradient is run over 30 to 120 minutes.

109. A HPLC method according to claim 108, wherein the gradient is run over 30 to 60 minutes.

110. A HPLC method according to any one of claims 106 to 109, wherein the first liquid A is an aqueous solution of 0.007 M ammonium acetate and the second liquid B is acetonitrile.

111. A HPLC method according to claim 110, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

112. A HPLC method according to any one of claims 89 to 111, wherein the stationary phase is chiral.

113. A HPLC method according to any one of claims 89 to 112, wherein the mobile phase further comprises a chiral selector.

114. A HPLC method according to any one of claims 89 to 113, wherein the stationary phase is reverse phase.

115. A HPLC method according to claim 114, wherein the stationary phase used is octadecylsilyl silica gel, octylsilyl silica gel, phenylalkyl silica gel, cyanopropyl silica gel, aminopropyl silica gel or an alkyl-diol silica gel.

116. A HPLC method according to claim 115, wherein the stationary phase used is octadecylsilyl silica gel or octylsilyl silica gel.

117. A HPLC method according to claim 116, wherein the stationary phase comprises a YMC Pack pro C18 (250 mm×4.6 mm), 5μ column.

118. A HPLC method according to any one of claims 89 to 117, wherein the stationary phase has a particle size of between 0.1 and 100 μm.

119. A HPLC method according to claim 118, wherein the stationary phase has a particle size of about 5 μm.

120. A HPLC method according to any one of claims 89 to 119, wherein the stationary phase has a pore size of between 1 and 100 nm.

121. A HPLC method according to claim 120, wherein the stationary phase has a pore size of about 12 nm.

122. A HPLC method according to any one of claims 89 to 121, wherein the chromatography is carried out at a temperature between approximately 15 to 40° C.

123. A HPLC method according to any one of claims 89 to 122, wherein the chromatography is carried out in a column between 10 mm and 5000 mm in length.

124. A HPLC method according to claim 123, wherein the chromatography is carried out in a column about 250 mm in length.

125. A HPLC method according to any one of claims 89 to 124, wherein the chromatography is carried out in a column between 0.01 mm and 100 mm in internal diameter.

126. A HPLC method according to claim 125, wherein the chromatography is carried out in a column about 4.6 mm in internal diameter.

127. A HPLC method according to any one of claims 89 to 126, wherein the eluent is analysed by a detector such as a UV or visible spectrophotometer, a fluorescence spectrophotometer, a differential refractometer, an electrochemical detector, a mass spectrometer, a light scattering detector or a radioactivity detector.

128. A HPLC method according to any one of claims 89 to 127, wherein the formoterol is in the form of formoterol fumarate dihydrate.

129. A HPLC method according to any one of claims 89 to 128, which detects and optionally quantifies in a single run one or more of the following impurities:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

130. A method for analysing a substance, comprising the detection and optional quantification of one or more impurities selected from:
N-Benzyl-N-(1-methyl-2-p-methoxyphenylethyl) amine;
4-Benzyloxy-3-nitro-α-[N-benzyl-N-(1-methyl-2-p-methoxyphenylethyl)amino] acetophenone;
4-Benzyloxy-3-nitro-α-[N-benzyl-N-(1-methyl-2-p-methoxyphenylethyl)aminomethyl] benzyl alcohol diastereomer-I;
4-Benzyloxy-3-nitro-α-[N-benzyl-N-(1-methyl-2-p-methoxyphenylethyl)aminomethyl] benzyl alcohol diastereomer-II;
4-Benzyloxy-3-amino-α-[N-benzyl-N-(1-methyl-2-p-methoxyphenylethyl)aminomethyl] benzyl alcohol diastereomer-I;
4-Benzyloxy-3-amino-α-[N-benzyl-N-(1-methyl-2-p-methoxyphenylethyl)aminomethyl] benzyl alcohol diastereomer-II; and/or
4-Benzyloxy-3-formylamino-α-[N-benzyl-N-(1-methyl-2-p-methoxyphenylethyl) aminomethyl] benzyl alcohol.

131. A method as claimed in claim 130, wherein the substance is an active pharmaceutical ingredient.

132. A method as claimed in claim 130 or 131, wherein the substance is formoterol.

133. A method as claimed in claim 132, wherein the formoterol is in the form of formoterol fumarate dihydrate.

134. A method as claimed in any of claims 130 to 133, wherein the substance comprises less than 25 wt. % of the one or more impurities.

135. A method as claimed in any of claims 130 to 134, wherein the method comprises the use of HLPC.

136. A method as claimed in claim 135, wherein the mobile phase comprises two or more liquids, including a first liquid A and a second liquid B.

137. A method according to claim 136, wherein the first liquid A is aqueous based.

138. A method according to claim 137, wherein the first liquid A comprises water or an aqueous solution of a buffer.

139. A method according to claim 138, wherein the buffer is an acid or an organic salt or an inorganic salt.

140. A method according to claim 139, wherein the buffer is a phosphate salt, an acetate salt, a formate salt or trifluoroacetic acid.

141. A method according to claim 139 or 140, wherein the buffer is an ammonium salt.

142. A method according to claim 141, wherein the buffer is ammonium acetate.

143. A method according to any one of claims 138 to 142, wherein the buffer is present at a concentration of 0.001 to 0.1 M.

144. A method according to claim 143, wherein the buffer is present at a concentration of 0.001 to 0.01 M.

145. A method according to claim 144, wherein the buffer is present at a concentration of 0.005 to 0.01 M.

146. A method according to claim 145, wherein the buffer is present at a concentration of approximately 0.007 M.

147. A method according to any one of claims 138 to 146, wherein the pH of the buffer is approximately 2 to 6.

148. A method according to claim 147, wherein the pH of the buffer is between 3.8 and 5.8.

149. A method according to claim 148, wherein the pH of the buffer is about 4.8.

150. A method according to any one of claims 136 to 149, wherein the second liquid B is an organic solvent.

151. A method according to any one of claims 136 to 150, wherein the second liquid B is a substantially water miscible solvent.

152. A method according to any one of claims 136 to 151, wherein the second liquid B is a polar protic solvent such as acetic acid, methanol, ethanol, n-propanol or isopropanol, or a dipolar aprotic solvent such as acetone, acetonitrile, dimethoxyethane, DMF, DMSO, 1,4-dioxane, pyridine, or THF.

153. A method according to claim 150, wherein the second liquid B is selected from methanol, ethanol, acetonitrile, n-propanol, isopropanol, or a mixture thereof.

154. A method according to claim 153, wherein the second liquid B is acetonitrile.

155. A method according to any one of claims 136 to 154, wherein the first liquid A is an aqueous solution of ammonium acetate and the second liquid B is acetonitrile.

156. A method according to any one of claims 136 to 155, wherein a mobile phase flow rate of between 0.01 and 10 ml/min is used.

157. A method according to claim 156, wherein a mobile phase flow rate of about 1 ml/min is used.

158. A method according to any one of claims 136 to 157, wherein the method is an isocratic HPLC method.

159. A method according to claim 158, wherein the relative concentration of the liquids A and B is set between 99.5% A:0.5% B and 0.5% A:99.5% B.

160. A method according to claim 159, wherein the relative concentration of the liquids A and B is about 40% A:60% B.

161. A method according to any one of claims 136 to 157, wherein the relative concentration of the liquids of the mobile phase is varied to a predetermined gradient.

162. A method according to claim 161, which comprises a gradient programming so that the relative concentration of the liquids A and B are varied to a gradient between 99.5% A:0.5% B to 0.5% A:99.5% B run over 10 to 180 minutes.

163. A method according to claim 162, wherein the gradient is run over 30 to 120 minutes.

164. A method according to claim 163, wherein the gradient is run over 30 to 60 minutes.

165. A method according to any one of claims 161 to 164, wherein the first liquid A is an aqueous solution of 0.007 M ammonium acetate and the second liquid B is acetonitrile.

166. A method according to claim 165, wherein the gradient is as follows:

| Time (min) | % A | % B |
|---|---|---|
| 0 | 85 | 15 |
| 15 | 20 | 80 |
| 35 | 20 | 80 |
| 40 | 85 | 15 |
| 55 | 85 | 15 |

167. A method according to any one of claims 136 to 166, wherein the stationary phase is chiral.

168. A method according to any one of claims 136 to 167, wherein the mobile phase further comprises a chiral selector.

169. A method according to any one of claims 136 to 168, wherein the stationary phase is reverse phase.

170. A method according to claim 169, wherein the stationary phase used is octadecylsilyl silica gel, octylsilyl silica gel, phenylalkyl silica gel, cyanopropyl silica gel, aminopropyl silica gel or an alkyl-diol silica gel.

171. A method according to claim 170, wherein the stationary phase used is octadecylsilyl silica gel or octylsilyl silica gel.

172. A method according to claim 171, wherein the stationary phase comprises a YMC Pack pro C18 (250 mm×4.6 mm), 5μ column.

173. A method according to any one of claims 136 to 172, wherein the stationary phase has a particle size of between 0.1 and 100 μm.

174. A method according to claim 173, wherein the stationary phase has a particle size of about 5 μm.

175. A method according to any one of claims 136 to 174, wherein the stationary phase has a pore size of between 1 and 100 nm.

176. A method according to claim 175, wherein the stationary phase has a pore size of about 12 nm.

177. A method according to any one of claims 136 to 176, wherein the chromatography is carried out at a temperature between approximately 15 to 40° C.

178. A method according to any one of claims 136 to 177, wherein the chromatography is carried out in a column between 10 mm and 5000 mm in length.

179. A method according to claim 178, wherein the chromatography is carried out in a column about 250 mm in length.

180. A method according to any one of claims 136 to 179, wherein the chromatography is carried out in a column between 0.01 mm. and 100 mm in internal diameter.

181. A method according to claim 180, wherein the chromatography is carried out in a column about 4.6 mm in internal diameter.

182. A method according to any one of claims 136 to 181, wherein the eluent is analysed by a detector such as a UV or visible spectrophotometer, a fluorescence spectrophotometer, a differential refractometer, an electrochemical detector, a mass spectrometer, a light scattering detector or a radioactivity detector.
